(19) United States
(12) Patent Application Publication
(10) Pub. No.: US 2026/0065151 A1
(43) Pub. Date: Mar. 5, 2026

(54) LEARNING SYSTEM AND METHOD FOR TRAINING TASK-SPECIFIC LARGE LANGUAGE MODEL FROM UNLABELED DATA AND NON-TRANSITORY COMPUTER READABLE MEDIUM

(71) Applicant: CMONEY TECHNOLOGY CO., LTD., New Taipei City (TW)

(72) Inventors: Tzu-Hsuan CHOU, New Taipei City (TW); Yi-Zhen ZHANG, New Taipei City (TW); Chun-Nan CHOU, New Taipei City (TW)

(21) Appl. No.: 19/228,778

(22) Filed: Jun. 5, 2025

Related U.S. Application Data
(60) Provisional application No. 63/690,292, filed on Sep. 3, 2024.

(51) Int. Cl. G06N 20/00

(52) U.S. Cl. CPC G06N 20/00

(57) ABSTRACT

The present disclosure provides a learning method, which includes steps as follows. An initialization is performed to use at least one large language model (LLM) with a zero-shot learning through an unlabeled dataset, so as to derive a labeled set. An active learning loop is performed to train a task-specific LLM (TLLM) through labeled set.

This application claims priority to U.S. Provisional Application Ser. No. 63/690,292, filed Sep. 3, 2024, which is herein incorporated by reference in its entirety.

### BACKGROUND

### Field of Invention

The present invention relates to learning systems and methods, and more particularly, machine learning systems and methods.

### Description of Related Art

Recently, several works have shown that fine-tuning large language models (LLMs) on Natural Language Processing (NLP) tasks achieves the human-level performance. However, fine-tuning LLMs typically demands thousands or even millions of annotations, which increases the cost of adapting LLMs.

In view of the foregoing, there still exist some problems on the annotation costs that await further improvement. However, those skilled in the art sought vainly for a solution. Accordingly, there is an urgent need in the related field to find alternative ways to reduce the annotation costs.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides learning systems and methods, to solve or circumvent aforesaid problems and disadvantages in the related art.

Some embodiments of the present disclosure are related to a learning method. The learning method includes steps of: performing an initialization to use at least one large language model (LLM) with a zero-shot learning through an unlabeled dataset, so as to derive a labeled set; and performing an active learning loop to train a task-specific LLM (TLLM) through the labeled set.

In some embodiments of the present disclosure, as to the learning method, the step of performing the initialization includes: making a prediction for data points of the unlabeled dataset via the at least one LLM with the zero-shot learning, where a confidence value of each of the data points of the prediction is higher than a predetermined value.

In some embodiments of the present disclosure, as to the learning method, the step of performing the initialization further includes: querying at least one oracle to generate the labeled set based on the prediction of the at least one LLM with the zero-shot learning, where the labeled set includes annotations of the data points for one or more classes.

In some embodiments of the present disclosure, as to the learning method, the step of performing the active learning loop includes: training the TLLM by using the annotations in each iteration of the active learning loop; and after the TLLM is trained completely, when the TLLM does not meet at least one stopping criterion, applying a selection strategy to find selected candidates, and querying at least one oracle to provide one or more annotations for the selected candidates that are used to train the TLLM until the TLLM meets some combinations of the at least one stopping criterion.

In some embodiments of the present disclosure, as to the learning method, the learning method further includes: sampling one or more predictions made by the TLLM to generate sampled predictions; and using the at least one oracle to estimate a performance of the TLLM by examining the sampled predictions.

Some embodiments of the present disclosure are related to a non-transitory computer readable medium to store a plurality of instructions for commanding a computer to execute a learning method, and the learning method includes steps of: performing an initialization to use at least one large language model (LLM) with a zero-shot learning through an unlabeled dataset, so as to derive a labeled set; and performing an active learning loop to train a task-specific LLM (TLLM) through the labeled set.

In some embodiments of the present disclosure, as to the non-transitory computer readable medium, the step of performing the initialization includes: making a prediction for data points of the unlabeled dataset via the at least one LLM with the zero-shot learning, where a confidence value of each of the data points of the prediction is higher than a predetermined value.

In some embodiments of the present disclosure, as to the non-transitory computer readable medium, the step of performing the initialization further includes: querying at least one oracle to generate the labeled set based on the prediction of the at least one LLM with the zero-shot learning, where the labeled set includes annotations of the data points for one or more classes.

In some embodiments of the present disclosure, as to the non-transitory computer readable medium, the step of performing the active learning loop includes: training the TLLM by using the annotations in each iteration of the active learning loop; and after the TLLM is trained completely, when the TLLM does not meet at least one stopping criterion, applying a selection strategy to find selected candidates, and querying at least one oracle to provide one or more annotations for the selected candidates that are used to train the TLLM until the TLLM meets some combinations of the at least one stopping criterion.

In some embodiments of the present disclosure, as to the non-transitory computer readable medium, the learning method further includes: sampling one or more predictions made by the TLLM to generate sampled predictions; and using the at least one oracle to estimate a performance of the TLLM by examining the sampled predictions.

Some embodiments of the present disclosure are related to performing a learning system includes a storage device and a processor, and the processor is electrically connected to the storage device. The storage device is configured to store at least one instruction. The processor is configured to execute the at least one instruction for: performing an initialization to use at least one large language model (LLM) with a zero-shot learning through an unlabeled dataset, so as to derive a labeled set; and performing an active learning loop to train a task-specific LLM (TLLM) through the labeled set.

In some embodiments of the present disclosure, the initialization executed by the processor includes: making a prediction for data points of the unlabeled dataset via the at least one LLM with the zero-shot learning, where a confidence value of each of the data points of the prediction is higher than a predetermined value.

In some embodiments of the present disclosure, the initialization executed by the processor further includes: querying at least one oracle to generate the labeled set based on the prediction of the at least one LLM with the zero-shot learning, where the labeled set includes annotations of the data points for one or more classes.

In some embodiments of the present disclosure, the active learning loop executed by the processor includes: training the TLLM by using the annotations in each iteration of the active learning loop; and after the TLLM is trained completely, when the TLLM does not meet at least one stopping criterion, applying a selection strategy to find selected candidates, and querying at least one oracle to provide one or more annotations for the selected candidates that are used to train the TLLM until the TLLM meets some combinations of the at least one stopping criterion.

In some embodiments of the present disclosure, the processor is configured to execute the at least one instruction for: sampling one or more predictions made by the TLLM to generate sampled predictions; and using the at least one oracle to estimate a performance of the TLLM by examining the sampled predictions.

In view of the above, some embodiments of the present disclosure provide a learning system and a learning method that takes an unlabeled dataset as its input and finally produces a task-specific LLM (TLLM). The learning system and the learning method employ active learning paradigm in selecting the data for annotations and utilizes one or more off-the-shelf LLMs in the initialization stage of active learning to deal with the cold-start problem. The experimental results show that our proposed system can efficiently derive one or more TLLMs that outperform one or more LLMs without the task-specific knowledge, thereby reducing the annotation costs.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a flow chart of a learning method according to some embodiments of the present disclosure; and

FIG. 2 is a block diagram of a learning system according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

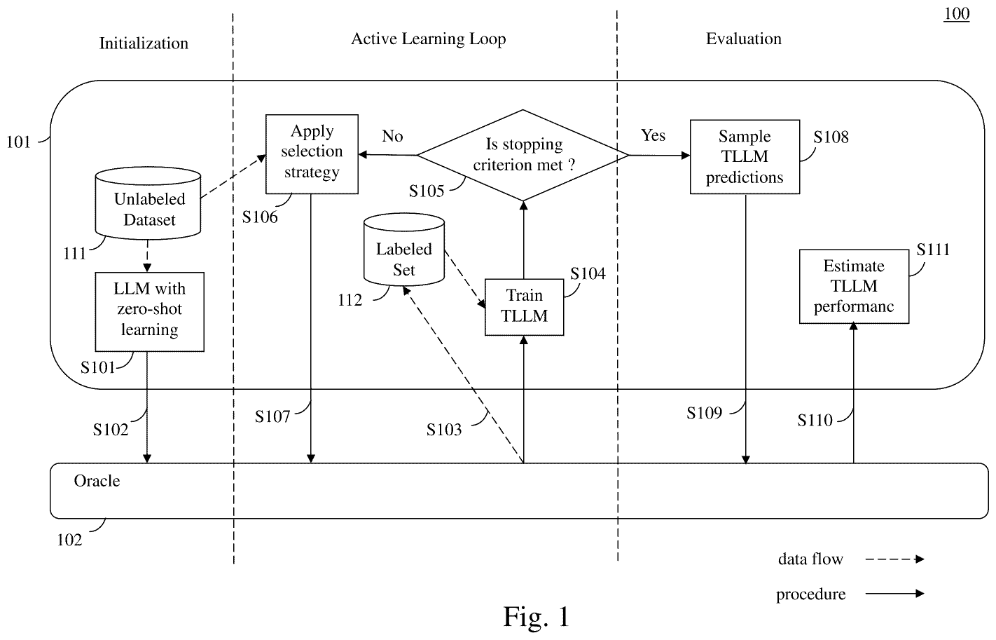

Referring to FIG. 1, in one aspect, the present disclosure is directed to a learning method 100 for training one or more task-specific large language models from unlabeled data. This learning method 100 may be easily integrated into a computer server and may be applicable or readily adaptable to all technologies. Accordingly, the learning method 100 has advantages. Herewith the learning method 100 is described below with FIG. 1.

The subject disclosure provides the learning method 100 in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

FIG. 1 is a flow chart of the learning method 100 according to an embodiment of the present disclosure. As shown in FIG. 1, the learning method 100 includes steps S101 to S111. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

The learning method 100 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

In FIG. 1, the active learning model framework 101 includes an initialization, an active learning loop and an evaluation. The goal of an active learning model framework 101 is to recognize the most relevant examples and then query labels from at least one oracle 102. An active learning process often consists of two stages: the initialization and the active learning loop.

Regarding the initialization, in a control experiment, an active learning process requires an initial labeled set to train a machine learning (ML) model that can better understand the task than that without a labeled set. The control experiment typically either assumes the existence of initial annotations or randomly samples data points to assign annotations. In the control experiment, the initialization stage always encounters the so-called cold-start situation. Intuitively, the random sampling may be applied to tackle the cold-start issue, which is prone to lead to the imbalanced distribution of the initial labeled set.

Regarding the active learning loop, in practice, for example, an active learning process takes multiple iterations to gather annotations. In each iteration procedure, an active learning process first trains a model with annotations at hand and then utilizes a selection strategy such as uncertainty sampling or diversity sampling to find annotation candidates. Once data points are selected as annotation candidates, the at least one oracle 102 is queried to derive annotations. Compared to random sampling, models trained on annotations gathered through an active learning process often perform better. The iteration repeats until some combinations of the at least one certain stopping criterion are met.

Regarding the initialization, in some embodiments of the present disclosure, in the initialization stage of the learning system, step S101 uses one or more LLMs with zero-shot learning to tackle the cold-start issue of active learning since our input dataset is unlabeled. First, step S101 make the initial prediction for each data point via zero-shot learning. Afterwards, based on the initial prediction, step S102 is to query the at least one oracle 102, and step S103 is to derive and collect annotations for each class. Since zero-shot learning may lead to the potential for problematic predictions, step S101 only consider the data points with high confidence. By using our initialization procedure, we can derive an initial labeled set (e.g., a labeled set 112) that is a balanced distribution without manually evaluating every data point.

Regarding the zero-shot learning, in practice, for example, one or more LLMs can perform downstream task without any parameter or architecture modification. Zero-shot learning is, in fact, a form of transfer learning. It involves reformulating tasks into one or more LLMs' pre-training tasks so that one or more LLMs can transfer knowledge from pre-training to solve downstream tasks. For example, the pre-training task of GPT3 is to predict the next token conditioned on the input tokens. Hence, the process can do binary classification tasks by prompting GPT3 to generate 0 or 1 as the next token for a given input.

Regarding the active learning loop, in some embodiments of the present disclosure, in each iteration procedure of this stage, step S104 firstly train a TLLM by using the annotations that have been collected so far and include those annotations obtained during the initialization stage. A TLLM can be fine-tuned if the training cost is affordable. Alternatively, step S104 can use an in-context few-shot learning to transform a task-agnostic LLM into TLLM.

Regarding the few-shot learning, in practice, for example, the few-shot learning is a machine learning method that can train on a very small number of labeled examples. Intuitively, few-shot learning is achieved by one or more fine-tuning LLMs with a few examples in the format of zero-shot learning. In-context learning is another way to carry out few-shot learning, where a few demonstrations and the actual input are fed to one or more LLMs as a prompt, and then one or more LLMs generate predictions as in zero-shot learning. The experiments have shown that one or more LLMs can be quickly adapted to new tasks with only a few demonstrations.

After a TLLM completes its training, in step S105, the at least one stopping criterion is evaluated. If the at least one stopping criterion is met, the active learning loop is stopped. Otherwise, step S106 is to apply a selection strategy to find annotation candidates, and subsequently one or more oracles provide the annotations for the selected candidates. The same loop repeats to gather more annotations until some combinations of the at least one stopping criterion are met, and better one or more TLLMs are desirable to emerge when annotations accumulate.

After the active learning process is finished, step S111 is to estimate the performance of the final TLLM. Since as usual there are no test sets available in the active learning scenario, step S108 is to sample the predictions made by the final TLLM, and step S109 is to ask the at least one oracle 102 to provide the corresponding answers in step S110. The final TLLM can be the TLLM obtained in the last active learning loop or can be other one or more LLMs trained using all annotations derived from the active learning process. In both cases, the learning method 100 exploits the final TLLM to gain the predictions of the unlabeled dataset 111 and then request the at least one oracle 102 to examine the predictions.

Regarding the at least one oracle 102, in practice, for example, depending on the requirement of annotation precision, at least one oracle that we refer in our system can be at least one person or at least one LLM. When high annotation precision is desired, the at least one oracle should be a person. If the annotations with noise can be acceptable or tolerated, the at least one oracle could be at least one LLM.

It should be noted that at least one oracle in the learning system plays three different roles as follows. First, in the initialization stage, at least one oracle 102 is queried to generate the initial labeled set based on the predictions of one or more LLMs with zero-shot learning. Second, in each iteration procedure of the active learning loop, at least one oracle 102 is queried to provide annotations for the selected data points that are used to train one or more TLLMs. Finally, at least one oracle 102 helps estimate the performance of the final TLLM by examining the sampled predictions.

In view of the above, in the learning method 100, an initialization is performed in steps S101 to S103 to use at least one large language model (LLM) with a zero-shot learning through an unlabeled dataset 111, so as to derive a labeled set 112, and an active learning loop is performed steps S104 to S107 to train a task-specific LLM (TLLM) through the labeled set 112.

In some embodiments of the present disclosure, a prediction for data points of the unlabeled dataset via the at least one LLM with the zero-shot learning is made in step S101, where a confidence value of each of the data points of the prediction is higher than a predetermined value.

In some embodiments of the present disclosure, at least one oracle 102 is queried in step S102 to generate the labeled set 112 based on the prediction of the at least one LLM with the zero-shot learning through step S103, where the labeled set 112 includes annotations of the data points for one or more classes.

In some embodiments of the present disclosure, the TLLM is trained in step S104 by using the annotations in each iteration of the active learning loop; and after the TLLM is trained completely, when the TLLM does not meet at least one stopping criterion as determined in step S105, a selection strategy is applied in step S106 to find selected candidates, and the at least one oracle 102 is queried in step S107 to provide one or more annotations for the selected candidates that are used to train the TLLM in step S104 until the TLLM meets some combinations of the at least one stopping criterion as determined in step S105.

In some embodiments of the present disclosure, one or more predictions made by the TLLM to generate sampled predictions is sampled in step S108; and the at least one oracle 102 is used in steps S109 and S110 to estimate a performance of the TLLM by examining the sampled predictions in step S111.

In order to evaluate the effectiveness of the learning system, some embodiments of the present disclosure use commodity name classification, i.e., commodity names are divided into different categories, as the demonstration example. The experimental results reveal that (1) one or more TLLMs with active learning outperform one or more TLLMs with random sampling and one or more LLMs with zero-shot learning, and (2) using at least one LLM as the at least one oracle in our system can achieve the competitive performance with the at least one human oracle.

For example, the unlabeled dataset 111 consists of commodity names, which are mainly written in Chinese. Initially, there are billions of commodity records in our unlabeled dataset. To boost our evaluation, the learning method 100 filters out commodities that are purchased less frequently in our experiments, thereby remaining 100 k commodities (contribute>60% of transaction records).

Even though the essence of commodity name classification is a multi-class classification task, without loss of generality, we further reformulate commodity name classification as a binary classification task by asking one or more LLMs whether a commodity belongs to a category. Two categories “coffee” and “tea” are chosen as exemplars.

Some embodiments of the present disclosure illustrate an implementation of our learning system to demonstrate the capability of obtaining one or more TLLMs that can solve the problem of commodity name classification. Some embodiments of the present disclosure follow the narrative structure of FIG. 1 to describe the details of the implementation.

Some embodiments of the present disclosure choose NSP-BERT as the LLM to perform zero-shot learning on the unlabeled dataset in all experiments. Some embodiments of the present disclosure regard commodity name classification task as a NSP (next sentence prediction) task. For example, in order to predict whether a commodity name belongs to the coffee category, the learning method 100 can deal with the task by using the following prompt template (S1, S2)=(“Commodity with name {commodity}”, “is belong to coffee category.”), and then ask NSP-BERT to predict whether S2 can be a next sentence of S1. If the answer is positive, NSP-BERT should output 1. Otherwise, NSP-BERT should output 0. In all our experiments, the learning method 100 uses the “bert-base-chinese” checkpoint. In order to form the annotation candidates, the learning method 100 finds K data points that NSP-BERT has the highest confidence in. After the annotation candidates are formed, we ask at least one oracle to provide annotations. Since commodity name classification is a binary classification task, the learning method 100 forces K/2 positive data points and K/2 negative data points to guarantee a balanced distribution for easing the subsequent training. In all experiments, the learning method 100 sets K to 16. Note that K throughout this subsection refers to the same one.

Some embodiments of the present disclosure choose NSP-BERT as the model architecture of TLLM in all our experiments. In each iteration of the active learning loop, the learning method 100 uses the same prompt template in the initialization stage of experiments and fine-tune NSP-BERT with the annotations accumulated so far. The learning method 100 uses Adam as the optimizer with learning rate of 1e-5, β1=0.9, β2=0.999, L2 weight decay of 0.01. The fine-tuning procedure is implemented by using PyTorch.

The learning method 100 uses pool-based uncertainty sampling as the selection strategy. In each iteration, the learning method 100 retrieves K data points that the fine-tuned NSP-BERT is most uncertain about and ask at least one oracle 102 to provide annotations.

In terms of the at least one stopping criterion, the learning method 100 stops the active learning loop when the maximum number of iterations is reached. In all experiments, the learning method 100 sets the maximum number of iterations to 9, which causes 160 annotations in total. The reason why the number of annotations is 160 instead of 144 is because the learning method 100 includes the annotations derived in the initialization stage.

The learning method 100 uses precision to estimate one or more TLLMs since the learning method 100 tackles the binary classification task. The learning method 100 samples N data points inferred to be positive and ask at least one oracle to provide the corresponding ground truth. N is set to 200 throughout all our experiments. Precision=(#True-Positive in population)/(#Inferred-Positive in population)=(#True-Positive in sample)/(#Inferred-Positive in sample)=(#True-Positive in sample)/N.

The learning method 100 compares one or more human oracles to one or more LLM oracles. In each experiment, only one oracle is involved in the learning process. In all experiments, the one or more human oracle is the same person, and the one or more LLM oracles are Gemini. More specifically, the learning method 100 uses gemini-flash-1.5-001 checkpoint for Gemini.

TABLE 1
Category: coffee

| Method | Oracle | Estimated Precision | #Inferred-Positive |
|---|---|---|---|
| LLM + ZL | Human | 18.0% | 60,649 |
| TLLM | Human | 96.5% | 1,102 |
| TLLM + AL | Human | 98.0% | 4,249 |
| TLLM + AL | LLM | 95.0% | 2,535 |

TABLE 2
Category: tea

| Method | Oracle | Estimated Precision | #Inferred-Positive |
|---|---|---|---|
| LLM + ZL | Human | 20.5% | 46,111 |
| TLLM | Human | 83.0% | 4,253 |
| TLLM + AL | Human | 95.0% | 4,320 |
| TLLM + AL | LLM | 93.0% | 8,434 |

Table 1 shows the estimated performance of coffee-categorization task, where #Inferred-Positive means the number of positive data points inferred by TLLM. Table 2 shows the estimated performance of tea-categorization task, where #Inferred-Positive means the number of positive data points inferred by TLLM.

To show the effectiveness of TLLM, the learning method 100 compares NSP-BERT with active learning (denoted as TLLM+AL) to NSP-BERT with zero-shot learning (denoted as LLM+ZL). In order to have a fair comparison, the learning method 100 uses the same prompt template for all settings.

To evaluate the impact of active learning, the learning method 100 also compares NSP-BERT with active learning and NSP-BERT with randomly selected positive samples (denoted as TLLM). To derive annotations without active learning, we use the results of zero-shot learning to derive annotation candidates that NSP-BERT is highly confident in and ask a person to provide annotations.

In both the coffee and tea experiments (see rows three to five in both Tables 1 and 2), some embodiments of the present disclosure found that one or more TLLMs, even without active learning, have significantly outperformed one or more LLMs with zero-shot learning. The huge difference suggests that while one or more LLMs can perform adequately across a range of tasks, their performance may not be competitive to models fine-tuned for specific tasks.

In both the coffee and tea experiments (see rows four and five in both Tables 1 and 2), some embodiments of the present disclosure found that TLLM+AL has the best precision among the other methods. The difference between TLLM with and without active learning can be up to 12%. The results suggest that the combination of task-specific fine-tuning and active learning creates a synergistic effect, where the model not only learns from the most relevant data but also from the most informative data.

In both the coffee and tea experiments (see rows five and six in both Tables 1 and 2), some embodiments of the present disclosure found that using one or more LLMs as one or more oracles instead of one or more human oracles does not make much difference in terms of precision. The results suggest that one or more LLMs may serve as effective surrogate for one or more human oracles in the active learning process. The comparable performance indicates that one or more LLM oracles are capable of providing high-quality annotations during the learning process.

The learning system can effectively resolve the problem of commodity name classification by utilizing active learning and one or more LLMs. By addressing the cold-start issue with zero-shot learning and fine-tuning on annotations derived from active learning, we demonstrate that one or more TLLMs significantly outperform one or more LLMs without task-specific knowledge. Additionally, one or more LLMs show the potential to be one alternative to at least one human oracle and thus open the use of automating and scaling the annotation process.

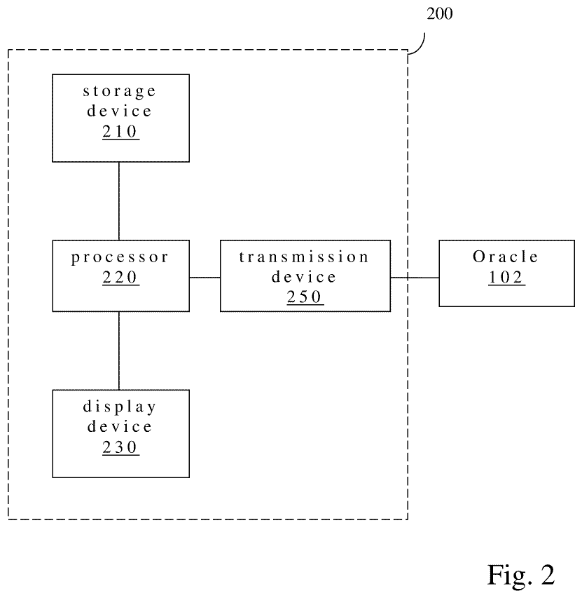

For a more complete understanding of the learning method 100 performed by a learning system 200, referring FIG. 1 and FIG. 2, FIG. 2 is a block diagram of a learning system 200 according to some embodiments of the present disclosure. As shown in FIG. 2, the learning system 200 can includes a storage device 210, a processor 220, a display device 230 and a transmission device 250. For example, the storage device 210 can be a hard disk, flash storage device or another storage circuit, the processor 220 can be a central processor, a controller or another circuit, the display device 230 can be a built-in display device or an external screen, and the transmission device 250 can be a transmission line, a communication device or another transmission circuit.

In structure, the learning system 200 is electrically connected to the at least one oracle 102, the storage device 210 is electrically connected to the processor 220, the processor 220 is electrically connected to the display device 230, and the processor 220 is electrically connected to the transmission device 250. In practice, for example, the at least one oracle 102 may include one or more oracles. In some embodiments of the present disclosure, the at least one oracle 102 is computer hardware of executing at least one LLM.

In use, the storage device 210 is configured to store at least one instruction and an unlabeled dataset 111. The processor 220 is configured to execute the at least one instruction for: performing an initialization to use at least one large language model (LLM) with a zero-shot learning through the unlabeled dataset 111, so as to derive a labeled set 112, and the labeled set 112 can be stored in the storage device 210; and performing an active learning loop to train a task-specific LLM (TLLM) through the labeled set 112.

In some embodiments of the present disclosure, the initialization executed by the processor 220 includes: making a prediction for data points of the unlabeled dataset 111 via the at least one LLM with the zero-shot learning, where a confidence value of each of the data points of the prediction is higher than a predetermined value.

In some embodiments of the present disclosure, the initialization executed by the processor 220 further includes: querying at least one oracle to generate the labeled set 112 based on the prediction of the at least one LLM with the zero-shot learning, where the labeled set includes annotations of the data points for one or more classes.

In some embodiments of the present disclosure, the active learning loop executed by the processor includes: training the TLLM by using the annotations in each iteration of the active learning loop; and after the TLLM is trained completely, when the TLLM does not meet at least one stopping criterion, applying a selection strategy to find selected candidates, and querying the at least one oracle 102 to provide one or more annotations for the selected candidates that are used to train the TLLM until the TLLM meets some combinations of the at least one stopping criterion.

In some embodiments of the present disclosure, the processor 220 is configured to execute the at least one instruction for: sampling one or more predictions made by the TLLM to generate sampled predictions; and using the at least one oracle to estimate a performance of the TLLM by examining the sampled predictions. The display device 230 can show the estimate result.

In view of the above, some embodiments of the present disclosure provide a learning system 200 and a learning method 100 that takes an unlabeled dataset as its input and finally produces a task-specific LLM (TLLM). The learning system 200 and the learning method 100 employ active learning paradigm in selecting the data for annotations and utilizes one or more off-the-shelf LLMs in the initialization stage of active learning to deal with the cold-start problem. The experimental results show that our proposed system can efficiently derive one or more TLLMs that outperform one or more LLMs without the task-specific knowledge, thereby reducing the annotation costs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A learning method, comprising steps of:
performing an initialization to use at least one large language model (LLM) with a zero-shot learning through an unlabeled dataset, so as to derive a labeled set; and
performing an active learning loop to train a task-specific LLM (TLLM) through the labeled set.

2. The learning method of claim 1, wherein the step of performing the initialization comprises:
making a prediction for data points of the unlabeled dataset via the at least one LLM with the zero-shot learning, wherein a confidence value of each of the data points of the prediction is higher than a predetermined value.

3. The learning method of claim 2, wherein the step of performing the initialization further comprises:
querying at least one oracle to generate the labeled set based on the prediction of the at least one LLM with the zero-shot learning, wherein the labeled set comprises annotations of the data points for one or more classes.

4. The learning method of claim 3, wherein the step of performing the active learning loop comprises:
training the TLLM by using the annotations in each iteration of the active learning loop; and
after the TLLM is trained completely, when the TLLM does not meet at least one stopping criterion, applying a selection strategy to find selected candidates, and querying the at least one oracle to provide one or more annotations for the selected candidates that are used to train the TLLM until the TLLM meets some combinations of the at least one stopping criterion.

5. The learning method of claim 4, further comprising:
sampling one or more predictions made by the TLLM to generate sampled predictions; and
using the at least one oracle to estimate a performance of the TLLM by examining the sampled predictions.

6. A non-transitory computer readable medium to store a plurality of instructions for commanding a computer to execute a learning method, and the learning method comprising:
performing an initialization to use at least one large language model (LLM) with a zero-shot learning through an unlabeled dataset, so as to derive a labeled set; and
performing an active learning loop to train a task-specific LLM (TLLM) through the labeled set.

7. The non-transitory computer readable medium of claim 6, wherein the step of performing the initialization comprises:
making a prediction for data points of the unlabeled dataset via the at least one LLM with the zero-shot learning, wherein a confidence value of each of the data points of the prediction is higher than a predetermined value.

8. The non-transitory computer readable medium of claim 7, wherein the step of performing the initialization further comprises:
querying at least one oracle to generate the labeled set based on the prediction of the at least one LLM with the zero-shot learning, wherein the labeled set comprises annotations of the data points for one or more classes.

9. The non-transitory computer readable medium of claim 8, wherein the step of performing the active learning loop comprises:
training the TLLM by using the annotations in each iteration of the active learning loop; and
after the TLLM is trained completely, when the TLLM does not meet at least one stopping criterion, applying a selection strategy to find selected candidates, and querying the at least one oracle to provide one or more annotations for the selected candidates that are used to train the TLLM until the TLLM meets some combinations of the at least one stopping criterion.

10. The non-transitory computer readable medium of claim 9, wherein the learning method further comprises:
sampling one or more predictions made by the TLLM to generate sampled predictions; and
using the at least one oracle to estimate a performance of the TLLM by examining the sampled predictions.

11. A learning system, comprising:
a storage device configured to store at least one instruction; and
a processor electrically connected to the storage device, and the processor configured to execute the at least one instruction for:
performing an initialization to use at least one large language model (LLM) with a zero-shot learning through an unlabeled dataset, so as to derive a labeled set; and
performing an active learning loop to train a task-specific LLM (TLLM) through the labeled set.

12. The learning system of claim 11, wherein the initialization executed by the processor comprises:
making a prediction for data points of the unlabeled dataset via the at least one LLM with the zero-shot learning, wherein a confidence value of each of the data points of the prediction is higher than a predetermined value.

13. The learning system of claim 12, wherein the initialization executed by the processor further comprises:
querying at least one oracle to generate the labeled set based on the prediction of the at least one LLM with the zero-shot learning, wherein the labeled set comprises annotations of the data points for one or more classes.

14. The learning system of claim 13, wherein the active learning loop executed by the processor comprises:
training the TLLM by using the annotations in each iteration of the active learning loop; and
after the TLLM is trained completely, when the TLLM does not meet at least one stopping criterion, applying a selection strategy to find selected candidates, and querying the at least one oracle to provide one or more annotations for the selected candidates that are used to train the TLLM until the TLLM meets some combinations of the at least one stopping criterion.

15. The learning system of claim 14, wherein the processor is configured to execute the at least one instruction for:
sampling one or more predictions made by the TLLM to generate sampled predictions; and
using the at least one oracle to estimate a performance of the TLLM by examining the sampled predictions.
